(19) United States
(12) Patent Application Publication
(10) Pub. No.: US 2008/0195757 A1
(43) Pub. Date: Aug. 14, 2008

(54) METHOD AND APPARATUS FOR AUTOMATICALLY RECOGNIZING A CONNECTION OF A DEVICE TO A BUILDING MANAGEMENT SYSTEM

(75) Inventors: Ki-Bum KIM, Seoul (KR); Sang-Chul YOUN, Seoul (KR); Duck-Gu JEON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/972,195

(22) Filed: Jan. 10, 2008

(30) Foreign Application Priority Data
Feb. 8, 2007 (KR) 10-2007-0013384

(51) Int. Cl. G06F 15/16

(52) U.S. Cl. 709/245; 709/203

(57) ABSTRACT

Disclosed is a method and apparatus for automatically recognizing a device of a building management system which is capable of automatically recognizing a device when the device is connected to or removed from a certain communication port that is built into a BACnet gateway of a building management system, thereby providing convenience to a user and an installer and increasing operational efficiency of the building management system.

### BACKGROUND OF THE INVENTION

1. Field of the Invention

The present invention relates to a method and apparatus for automatically recognizing a connection of a device to a building management system, and more particularly, to a method and apparatus for automatically recognizing a connection of a device of building management system capable of automatically recognizing a device when the device is connected to or removed from a certain communication port that is built into a BACnet gateway of a building management system, thereby providing convenience to a user and an installer and increasing operational efficiency of the building management system.

2. Description of the Background Art

FIG. 1 schematically illustrates a structure of a related art building management system.

As shown in FIG. 1, the building management system includes a central control system 110 for performing a central control function for sub-systems, such as power, lighting, etc. that are networked to each other and installed inside a building, a plurality of sub-systems 120 for managing lighting, an air conditioning system, security, etc. of a building, and a BACnet gateway 130 serving as a connection path between the central control system 110 and the sub-systems 120 such that the central control system 110 can centrally control the sub-systems 120.

In addition, the BACnet gateway 130 is provided with a plurality of communication ports 131, 132, 133 and 134 for connecting the plurality of sub-systems 120 with the central control system 110.

In order for the central control system 110 to control or monitor the sub-systems 120, the sub-systems connected to the BACnet gateway 130 and devices included in the sub-systems 120 need to be connected to each of the ports 131, 132, 133 and 134 that are built into the BACnet gateway 130. Further, a resetting operation is required if a new sub-system or device is added or an existing sub-system or device is removed.

In the device recognition method of the related art building management system, when sub-systems or devices are connected to the BACnet gateway 130, the number of connected sub-systems or devices needs to be set in the BACnet gateway 130, and then respective sub-systems or devices should be allotted to each of the ports of the BACnet gateway 130. Further, a resetting operation is required whenever a new sub-system or new device is added or an existing sub-system or device is removed, thereby causing inconvenience to a system manager in operating the building management system.

### SUMMARY OF THE INVENTION

Therefore, it is an object of the present invention to provide a method and apparatus for automatically recognizing a connection of a device to a building management system which is capable of automatically recognizing a device when the device is connected, added to or removed from a certain communication port that is included in a BACnet gateway of the building management system, thereby providing convenience to a user and an installer and increasing operational efficiency of the building management system.

To achieve these and other advantages and in accordance with the purpose of the present invention, as embodied and broadly described herein, there is provided a method for automatically recognizing the connection of a device to a building management system, comprising: transmitting a request signal through a communication port built into a BACnet gateway for checking a device connection; checking for a response signal with respect to the request signal; and if the response signal is received, recognizing that the device is connected to the communication port. Based on the recognition result, a recognition number is provided to the connected device, and a first table is written based on the recognition number. In addition, based on the written first table, communication is performed with the connected device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the description serve to explain the principles of the invention.

In the drawings:

FIG. 1 is a block diagram which schematically illustrates the structure of a related art building management system;

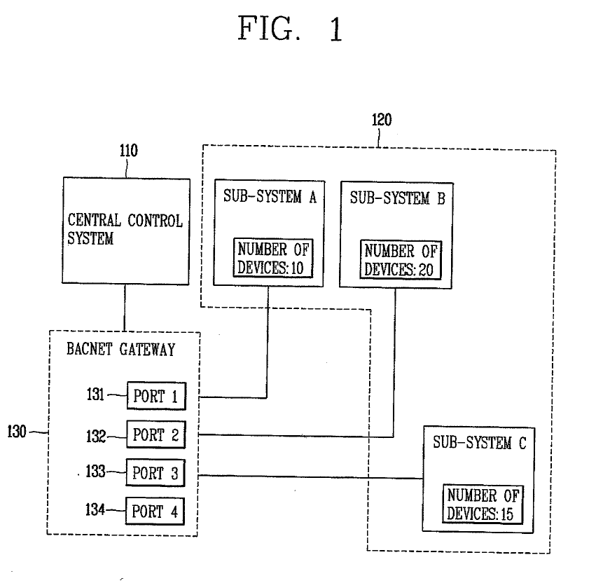

FIG. 2 is a flowchart illustrating a method for automatically recognizing a device of a building management system according to the present invention; and

FIG. 3 is a block diagram which schematically illustrates an apparatus for automatically recognizing a device of a building management system according to the present invention.

### DETAILED DESCRIPTION OF THE INVENTION

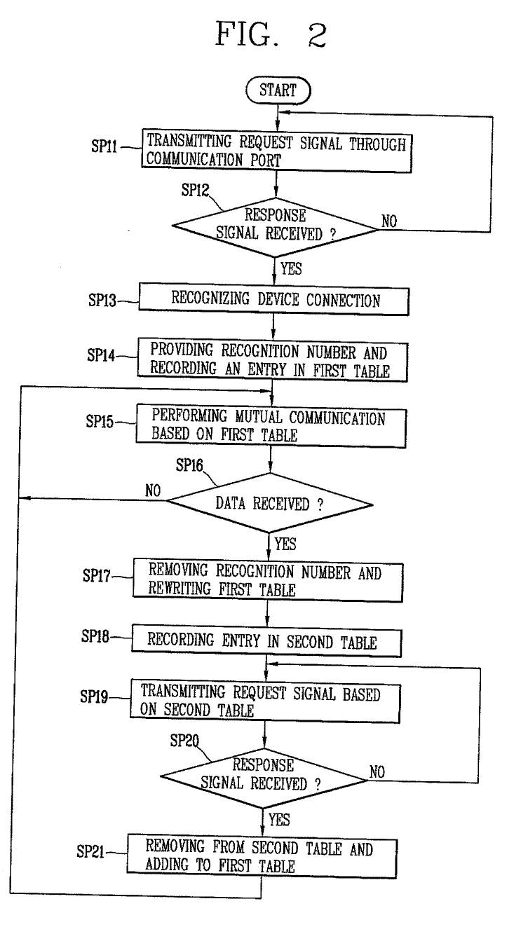

Description will now be given in detail of the method for automatically recognizing a device of a building management system according to the present invention with reference to FIG. 2 which is a flowchart illustrating the method for automatically recognizing a device of a building management system according to the present invention.

As shown in the drawing, the method for automatically recognizing a connection of a device according to the present invention includes: transmitting a request signal from a communication port of a BACnet gateway (SP11), determining whether a response signal has been received at the communication port responsive to the request signal (SP12), and if a response signal has been received, recognizing that the device is connected to the communication port (SP13).

A central control system of the building management system transmits a request signal through the communication port built into the BACnet gateway for checking the device connection (SP11). Upon receiving the request signal, a device connected to the port transmits a response signal in response to the request signal. In addition, the central control system determines whether or not a response signal is received in response to the request signal (SP12), and if the response signal is received, recognizes that the device is connected through the communication port (SP13). If the central control system has not received a response signal from the device in response to the request signal, the central control system re-transmits the request signal a certain number of times. Here, a communication format of the request signal and the response signal is determined by a communication protocol established among the central control system, the BACnet gateway and each of the devices, and the certain number of times can be set as 3 times, 5 times, or the like by a user or an installer.

The method according to the present invention may further include the steps of assigning a connected device a recognition number, and recording an entry based on the recognition number in a first table (SP14), and, based on the first table, performing communication with the device based on the entry in the first table (SP15). That is, if the device is recognized to be connected, the central control system assigns to the device a recognition number, and records an entry in a first table based on the recognition number, and then, based on the entry in the first table, performs communication with the connected device through the BACnet gateway (SP15). In the communication method, the central control system may individually perform communication with each of the devices that are recorded in the first table, or may control a group of devices based on entries of connected devices recorded in the first table. Here, the recognition number may correspond to a unique network address, and the like for classifying each of the respective connected devices.

The method according to the present invention may further include the steps of, while performing the communication, and if there is no data received from the device, removing the recognition number for the device that has no data from the first table, and then rewriting the first table (SP16 and SP17). Based on the first table, the communication is performed between the central control system and the devices connected to the central control system. That is, while data is being sent and received, and if there is no data received from a device, the device is determined to be disconnected, and thus the recognition number of the connected device recorded in the first table is removed and the first table is updated (SP16 and SP17). In addition, the central control system records an entry, based on the recognition number for the device removed from the first table in a second table (SP18).

The method according to the present invention may further include the steps of transmitting a request signal based on the entry in the second table (SP19), determining whether a response signal has been received responsive to the request signal (SP20), and if the response signal is received, recognizing that the device is connected to the communication port, removing the entry from the second table and adding an entry of the connected device back into the first table (SP21). That is, in order to determine whether the device that was once connected but disconnected is again connected, the central control system transmits the request signal based on the second table, thereby re-performing the procedure for automatically recognizing the device.

Accordingly, the method for automatically recognizing a device of a building management system according to the present invention sends and receives data through communication with a connected device based on an entry of the first table, and continues to check whether the device is connected based on the second table. Here, the first and second tables may be composed or constructed in the form of a database (DB), a file, or the like.

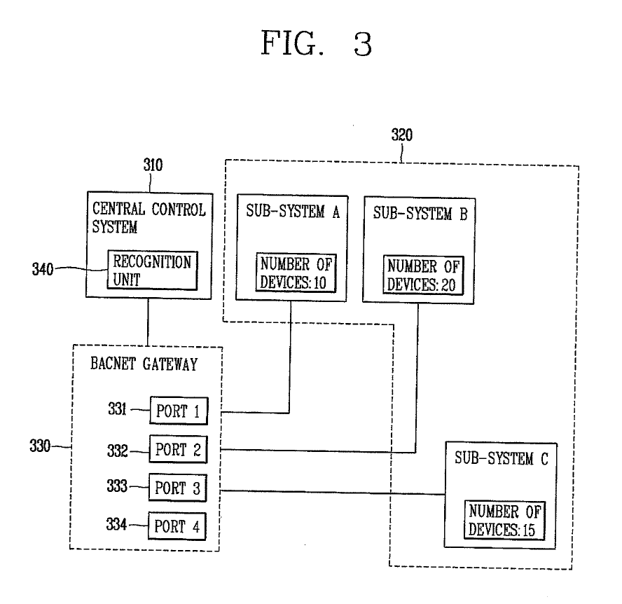

The method according to the present invention can be generally performed in the central control system, but can also be performed through the BACnet gateway or a separate device (e.g., a recognition unit in FIG. 3 to be described below).

Hereinafter, the apparatus for automatically recognizing a device of the building management system according to the present invention will be described in detail with reference to FIG. 3.

FIG. 3 schematically illustrates the apparatus for automatically recognizing a connection of a device to a building management system according to the present invention.

As shown in FIG. 3, the apparatus for automatically recognizing a device according to the present invention augments the related art building management system including a central control system 310 for performing a central control function for sub-systems, such as power, lighting, etc. that are networked to each other and installed inside the building, the plurality of sub-systems 320 for managing lighting, an air conditioning system, security, etc. of the building, and a BACnet gateway 330 serving as a connection path between the central control system 310 and the sub-systems 320 such that the central control system 310 can centrally control the sub-systems 320 by further including a recognition unit 340 which may be included in the central control system 310 or implemented in the BACnet gateway 330 or as a separate device.

The recognition unit transmits a request signal for checking the device connection from a communication port of a BACnet gateway, determines whether a response signal has been received at the communication port responsive to the request signal, and recognizes that the device is connected to the communication port if a response signal has been received. Also, the recognition unit may retransmit the request signal a certain number of times if a response signal is not received.

In addition, the apparatus for automatically recognizing a device according to the present invention assigns the connected device a recognition number, and records an entry based on the recognition number in a first table. Here, the apparatus may control a group of devices based on entries of connected devices recorded in the first table. While communication is being performed with the device as thusly recorded in the first table, if there is no data received, the apparatus records an entry based on the device that has no data in a second table. The recognition unit removes the entry from the first table, if data is not received from the device during the communication between the BACnet gateway and the device. Here, the recognition number corresponds to a network address, and the like for classifying each device.

In addition, the apparatus for automatically recognizing a device according to the present invention may further include a storage unit for storing the first table and the second table, and a control unit for recognizing whether the device is connected so as to provide the connected device with a recognition number and for performing communication with the device based on the recognition number. The storage unit stores the first table in which an entry is recorded based on the recognition number. Also, the storage unit further includes the second table, and the apparatus records an entry based on the recognition number in the second table when the entry is removed from the first table. Here, the first table and the second table may be composed in the form of a database (DB), a file, or the like. A hard disk, a memory and the like can be used for the storage unit.

The recognition unit transmits a request signal based on the entry in the second table, determines whether a response signal has been received responsive to the request signal, and recognizes that the device is connected to the communication port if a response signal is received. Also, the recognition unit removes the entry from the second table and adds an entry of the connected device to the first table.

The method and apparatus according to the present invention can also be applied to sub-systems including a plurality of devices.

Therefore, a building management system implementing the method for automatically recognizing a device according to the present invention may be initially constructed regardless of the number of sub-systems or devices, and even though a new sub-system or device is added or an existing sub-system or device is removed while the building management system is being operated, the building management system can automatically recognize the concerned sub-system or device by repeatedly performing the above-mentioned procedures periodically.

As so far described, the method and apparatus for automatically recognizing a device of a building management system according to the present invention can provide convenience to the user and the installer and increase the operational efficiency of the building management system by continually performing an automatic recognition of a device when the device is connected, added to or removed from a certain communication port that is built into the BACnet gateway.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present inventive features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for automatically recognizing a connection of a device to a building management system, comprising:
transmitting a request signal from a communication port of a BACnet gateway;
determining whether a response signal, responsive to the request signal, has been received at the communication port; and
if a response signal has been received, recognizing that the device is connected to the communication port.

2. The method of claim 1, further comprising:
assigning the connected device a recognition number; and
recording an entry based on the recognition number in a first table.

3. The method of claim 2, further comprising:
performing communication with the device based on the entry in the first table.

4. The method of claim 2, further comprising:
removing the entry from the first table, if data is not received from the device during the communication.

5. The method of claim 4, further comprising:
recording an entry based on the recognition number in a second table when the entry is removed from the first table.

6. The method of claim 5, further comprising:
transmitting a request signal based on the entry in the second table;
determining whether a response signal, responsive to the request signal, has been received; and
if a response signal is received, recognizing that the device is connected to the communication port.

7. The method of claim 6, further comprising:
removing the entry from the second table; and
adding an entry of the connected device to the first table.

8. The method of claim 2, further comprising:
controlling a group of devices based on entries of connected devices recorded in the first table.

9. The method of claim 2, wherein the recognition number is a network address.

10. The method of claim 1, further comprising:
if a response signal is not received, re-transmitting the request signal a certain number of times.

11. An apparatus for automatically recognizing a connection of a device to a building management system, comprising
a recognition unit which transmits a request signal from a communication port of a BACnet gateway, determines whether a response signal, responsive to the request signal, has been received at the communication port, and recognizes that the device is connected to the communication port if a response signal has been received.

12. The apparatus of claim 11, further comprising:
a control unit that assigns the connected device a recognition number; and
a storage unit which stores a first table in which an entry is recorded based on the recognition number.

13. The apparatus of claim 12, wherein the recognition unit removes the entry from the first table, if data is not received from the device during a communication between the BACnet gateway and the device.

14. The apparatus of claim 13, wherein the storage unit further comprises a second table, and the apparatus records an entry based on the recognition number in the second table when the entry is removed from the first table.

15. The apparatus of claim 14, wherein the recognition unit transmits a request signal based on the entry in the second table, determines whether a response signal, responsive to the request signal, has been received, and recognizes that the device is connected to the communication port if a response signal is received.

16. The apparatus of claim 15, wherein the recognition unit removes the entry from the second table and adds an entry of the connected device to the first table.

17. The apparatus of claim 12, wherein a group of devices are controlled based on entries of connected devices recorded in the first table.

18. The apparatus of claim 12, wherein the recognition number is a network address.

19. The apparatus of claim 11, wherein the recognition unit retransmits the request signal a certain number of times if a response signal is not received.
